(19) United States
(12) Patent Application Publication
(10) Pub. No.: US 2020/0332180 A1
(43) Pub. Date: Oct. 22, 2020

(54) QUANTUM DOT COMPOSITIONS INCLUDING POLYCARBONATE AND ACRYLIC BLENDS AND METHODS OF MANUFACTURE

(71) Applicant: SABIC GLOBAL TECHNOLOGIES B.V., Bergen op Zoom (NL)

(72) Inventors: Bing ZHOU, Mount Vernon, IN (US); Jan Henk KAMPS, Bergen op Zoom (NL); Christopher Luke HEIN, Mount Vernon, IN (US); Manojkumar CHELLAMUTHU, Mount Vernon, IN (US); Hao ZHOU, Mount Vernon, IN (US); Adel Fawzy BASTAWROS, Mount Vernon, IN (US); Pooja BAJAJ, Selkirk, NY (US)

(21) Appl. No.: 16/643,129

(22) PCT Filed: Aug. 29, 2018
(86) PCT No.: PCT/US2018/048455

§ 371 Date: Feb. 28, 2020

Related U.S. Application Data
(60) Provisional application No. 62/551,384, filed on Aug. 29, 2017.

(51) Int. Cl. C09K 11/02; C08L 69/00; C08J 3/22; C08J 5/18; B29C 48/08

(52) U.S. Cl. CPC C09K 11/02; C08L 69/00; B82Y 20/00; C08J 5/18; B29C 48/08; C08J 3/226

(57) ABSTRACT

Disclosed is a quantum dot composition comprising: a polycarbonate resin, a polycarbonate copolymer resin, or a combination thereof; a quantum dot concentrate including a plurality of nanoparticle quantum dots and an acrylic polymer, a methacrylic polymer, or a combination thereof; and a compatibilizer for promoting dispersion of the nanoparticle quantum dots in the quantum dot composition. The compatibilizer includes a transesterification catalyst, a physical compatibilizer, a plurality of semiconductor nanopartides passivated with a metal oxide, or a combination thereof. Further disclosed is a method for making a quantum dot composition, the method including: forming a quantum dot concentrate by combining a plurality of nanoparticle quantum dots with an acrylic polymer, a methacrylic polymer or a combination thereof; and combining the quantum dot concentrate with a compatibilizer and a polycarbonate resin, a polycarbonate copolymer resin, or a combination thereof.

### FIELD OF THE DISCLOSURE

The present disclosure relates to quantum dot compositions, and in particular, to quantum dot compositions including polycarbonate, acrylic and a compatibilizer that promotes dispersion of the quantum dots in the composition.

### BACKGROUND OF THE DISCLOSURE

Semiconductor nanoparticles (also known as quantum dots or nanocrystals) are increasingly being engineered and incorporated into polymer materials in both industrial and academic applications. Many nanoparticles with high quantum yields contain inorganic cores and have an inorganic or organic shell structure. Inorganic shell materials such as metal oxides (for example, aluminum oxide Al₂O₃, magnesium oxide MgO, zinc oxide ZnO, among others) serve as passivation layers to the encapsulated nanoparticles, which shield them from harsh outer environmental conditions during the manufacturing process or during operation, and which helps the nanoparticles maintain their optical properties. Due to the chemical nature of passivation layers, they have a higher compatibility with certain polymer groups (for example, acrylic or acrylate) and limited compatibility to other polymer groups. It has been found that nanoparticles disperse more easily into polymers including polymer groups that have better affinity and compatibility with the nanoparticles, because the polymer groups wrap around individual nanoparticles and keep them apart in solution or polymer phases. However, the acrylic/acrylate polymer groups lack desired thermal and mechanical properties and are therefore not suitable as primary matrix materials for semiconductor nanoparticle applications.

Polymer blends can provide properties that may not be possible from a single polymer family and provide more flexibility in product design. Blends of polycarbonate and acrylic/acrylate, for example, may have improved toughness, ductility, thermal stability, photo stability, dimensional stability and gloss as compared to the acrylic/acrylate polymer by itself. There are at least two challenges arising from the use of polycarbonate and acrylic polymer blends in semiconductor nanoparticle applications, however:

(1) Incompatibility between acrylic and polycarbonate polymers leads to phase separation of the two polymer phases, causing opaqueness in semiconductor nanoparticle films/parts, poor interfacial adhesion between the two phases and a resultant weak mechanical strength; and (2) Polycarbonate polymer groups are not sufficiently compatible with common semiconductor nanoparticles, so when they are combined the semiconductor nanoparticles agglomerate, and typical extrusion processes for forming semiconductor nanoparticle films do not provide sufficient shear force to break down agglomerated nanoparticles or mixing power to homogeneously disperse the nanoparticles in the matrix polymer in the highly viscous melt phase.

Two methods have been used to improve the nanoparticle dispersion and material performance of semiconductor nanoparticles in such polymer blends, with limited success and/or usefulness:

(1) High shear mixing and high temperature processing can improve mixing of polycarbonate and acrylic blends, but the harsh processing conditions also increase the risk of degradation of the polymer and the semiconductor nanoparticles.

(2) Ligands designed and selected to be compatible with both polycarbonate and acrylic have been functionalized to the surface of the semiconductor nanoparticles. The resulting semiconductor nanoparticles have an improved compatibility to both polymer groups. Unfortunately, however, the selection and synthesis of ligands, and the surface modification of the nanoparticles, is challenging, time consuming and costly to scale-up and manufacture.

These and other shortcomings are addressed by aspects of the present disclosure.

### SUMMARY

Aspects of the disclosure relate to a quantum dot composition including: a polycarbonate resin, a polycarbonate copolymer resin, or a combination thereof a quantum dot concentrate including a plurality of nanoparticle quantum dots and an acrylic polymer, a methacrylic polymer, or a combination thereof; and a compatibilizer for promoting dispersion of the nanoparticle quantum dots in the quantum dot composition. The compatibilizer includes a transesterification catalyst, a physical compatibilizer, a plurality of semiconductor nanoparticles passivated with a metal oxide, or a combination thereof.

Aspects of the disclosure further relate to a method for making a quantum dot composition, including: forming a quantum dot concentrate by combining a plurality of nanoparticle quantum dots with an acrylic polymer, a methacrylic polymer or a combination thereof, and combining the quantum dot concentrate with a compatibilizer and a polycarbonate resin, a polycarbonate copolymer resin, or a combination thereof.

### DETAILED DESCRIPTION

The present disclosure can be understood more readily by reference to the following detailed description of the disclosure and the Examples included therein. In various aspects, the present disclosure pertains to quantum dot compositions including: a polycarbonate resin, a polycarbonate copolymer resin, or a combination thereof, a quantum dot concentrate including a plurality of nanoparticle quantum dots and an acrylic polymer, a methacrylic polymer, or a combination thereof; and a compatibilizer for promoting dispersion of the nanoparticle quantum dots in the quantum dot composition.

Before the present compounds, compositions, articles, systems, devices, and/or methods are disclosed and described, it is to be understood that they are not limited to specific synthetic methods unless otherwise specified, or to particular reagents unless otherwise specified, as such can, of course, vary. It is also to be understood that the terminology used herein is for the purpose of describing particular aspects only and is not intended to be limiting.

Various combinations of elements of this disclosure are encompassed by this disclosure, for example, combinations of elements from dependent claims that depend upon the same independent claim.

Moreover, it is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of aspects described in the specification.

All publications mentioned herein are incorporated herein by reference to disclose and describe the methods and/or materials in connection with which the publications are cited. Definitions

It is also to be understood that the terminology used herein is for the purpose of describing particular aspects only and is not intended to be limiting. As used in the specification and in the claims, the term “comprising” can include the embodiments “consisting of” and “consisting essentially of” Unless defined otherwise, all technical and scientific terms used herein have the same meaning as commonly understood by one of ordinary skill in the art to which this disclosure belongs. In this specification and in the claims which follow, reference will be made to a number of terms which shall be defined herein.

As used in the specification and the appended claims, the singular forms “a,” “an” and “the” include plural referents unless the context clearly dictates otherwise. Thus, for example, reference to “a compatibilizer” includes mixtures of two or more compatibilizers.

As used herein, the term “combination” is inclusive of blends, mixtures, alloys, reaction products, and the like.

Ranges can be expressed herein as from one value (first value) to another value (second value). When such a range is expressed, the range includes in some aspects one or both of the first value and the second value. Similarly, when values are expressed as approximations, by use of the antecedent ‘about,’ it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “about” and “at or about” mean that the amount or value in question can be the designated value, approximately the designated value, or about the same as the designated value. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

As used herein, the terms “optional” or “optionally” means that the subsequently described event or circumstance can or cannot occur, and that the description includes instances where said event or circumstance occurs and instances where it does not. For example, the phrase “optional additional content of acrylic polymer, methacrylic polymer, or a combination thereof” means that the additional content of acrylic/methacrylic polymer can or cannot be included and that the description includes compositions that both include and that do not include the addition content of acrylic/methacrylic polymer.

Disclosed are the components to be used to prepare the compositions of the disclosure as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds cannot be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the disclosure. Thus, if there are a variety of additional steps that can be performed it is understood that each of these additional steps can be performed with any specific aspect or combination of aspects of the methods of the disclosure.

References in the specification and concluding claims to parts by weight of a particular element or component in a composition or article, denotes the weight relationship between the element or component and any other elements or components in the composition or article for which a part by weight is expressed. Thus, in a compound containing 2 parts by weight of component X and 5 parts by weight component Y, X and Y are present at a weight ratio of 2:5, and are present in such ratio regardless of whether additional components are contained in the compound.

A weight percent of a component, unless specifically stated to the contrary, is based on the total weight of the formulation or composition in which the component is included.

As used herein, the terms “number average molecular weight” or “Mn” can be used interchangeably, and refer to the statistical average molecular weight of all the polymer chains in the sample and is defined by the formula:

$${M}_{n} = \frac{\sum {N}_{i} {M}_{i}}{\sum {N}_{i}} ,$$

where Mi is the molecular weight of a chain and Ni is the number of chains of that molecular weight. Mn can be determined for polymers, e.g., polycarbonate polymers, by methods well known to a person having ordinary skill in the art using molecular weight standards, e.g. polycarbonate standards or polystyrene standards, preferably certified or traceable molecular weight standards.

As used herein, the terms “weight average molecular weight” or “Mw” can be used interchangeably, and are defined by the formula:

$${M}_{w} = \frac{\sum {N}_{i} {M}_{i}^{2}}{\sum {N}_{i} {M}_{i}} ,$$

where Mi is the molecular weight of a chain and Ni is the number of chains of that molecular weight. Compared to Mn, Mw takes into account the molecular weight of a given chain in determining contributions to the molecular weight average. Thus, the greater the molecular weight of a given chain, the more the chain contributes to the Mw. Mw can be determined for polymers, e.g., polycarbonate polymers, by methods well known to a person having ordinary skill in the art using molecular weight standards, e.g., polycarbonate standards or polystyrene standards, preferably certified or traceable molecular weight standards.

The terms “BisA,” “BPA,” or “bisphenol A,” which can be used interchangeably, as used herein refers to a compound having a structure represented by the formula:

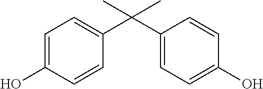 [SMILES: CC(C)(c1ccc(O)cc1)c1ccc(O)cc1]

BisA can also be referred to by the name 4,4′-(propane-2,2-diyl)diphenol; p,p′-isopropylidenebisphenol; or 2,2-bis(4-hydroxyphenyl)propane. BisA has the CAS # 80-05-7.

The terms “residues” and “structural units”, used in reference to the constituents of the polymers, are synonymous throughout the specification.

As used herein the terms “weight percent,” “wt %,” and “wt. %,” which can be used interchangeably, indicate the percent by weight of a given component based on the total weight of the composition, unless otherwise specified. That is, unless otherwise specified, all wt % values are based on the total weight of the composition. It should be understood that the sum of wt % values for all components in a disclosed composition or formulation are equal to 100.

Unless otherwise stated to the contrary herein, all test standards are the most recent standard in effect at the time of filing this application.

Each of the materials disclosed herein are either commercially available and/or the methods for the production thereof are known to those of skill in the art.

It is understood that the compositions disclosed herein have certain functions. Disclosed herein are certain structural requirements for performing the disclosed functions and it is understood that there are a variety of structures that can perform the same function that are related to the disclosed structures, and that these structures will typically achieve the same result.

### Quantum Dot Compositions

Aspects of the disclosure relate to a quantum dot composition including:

a. a polycarbonate resin, a polycarbonate copolymer resin, or a combination thereof;

b. a quantum dot concentrate including a plurality of nanoparticle quantum dots and an acrylic polymer, a methacrylic polymer, or a combination thereof; and

c. a compatibilizer for promoting dispersion of the nanoparticle quantum dots in the quantum dot composition.

The quantum dot composition includes a polycarbonate resin, a polycarbonate copolymer resin or a combination thereof. As used herein, polycarbonate refers to an oligomer or polymer comprising residues of one or more dihydroxy compounds, e.g., dihydroxy aromatic compounds, joined by carbonate linkages; it also encompasses homopolycarbonates, copolycarbonates, and (co)polyester carbonates. In some aspects the quantum dot composition includes from about 5 wt % to about 95 wt % polycarbonate resin/polycarbonate copolymer resin, or in particular aspects from about 20 wt % to about 80 wt % polycarbonate resin/polycarbonate copolymer resin.

The quantum dot composition includes a quantum dot concentrate including a plurality of nanoparticle quantum dots and an acrylic polymer, a methacrylic polymer, or a combination thereof.

In some aspects one or more of the plurality of nanoparticle quantum dots is a metal nanomaterial or an inorganic nanomaterial. The form of the plurality of nanoparticle quantum dots may include in certain aspects a nanoparticle, a nanofiber, a nanorod, or a nanowire.

Exemplary quantum dots according to aspects of the disclosure may include, but are not limited to, semiconductor nanocrystals selected from the group consisting of, but not limited to, Group II-VI semiconductor compounds, Group II-V semiconductor compounds, Group III-VI semiconductor compounds, Group III-V semiconductor compounds, Group IV-VI semiconductor compounds, Group compounds, Group II-IV-VI compounds, Group II-IV-V compounds, alloys thereof and combinations thereof.

Exemplary Group II elements include zinc Zn, cadmium Cd, mercury Hg or a combination thereof.

Exemplary Group III elements include aluminum Al, gallium Ga, indium In, titanium Ti or a combination thereof.

Exemplary Group IV elements include silicon Si, germanium Ge, tin Sn, lead Pb or a combination thereof.

Exemplary Group V elements include phosphorus P, arsenic As, antimony Sb, bismuth Bi or a combination thereof.

Exemplary Group VI elements include oxide 0, sulfur S, selenium Se, telluride Te or a combination thereof.

Exemplary Group II-VI semiconductor compounds include binary compounds, for example, cadmium selenium CdSe, cadmium sulfide CdS, cadmium telluride CdTe, zinc sulfide ZnS, zinc selenide ZnSe, zinc telluride ZnTe, zinc oxide ZnO, mercury sulfide HgS, mercury selenide HgSe and mercury selenide HgTe; ternary compounds, for example, cadmium selenide sulfide CdSeS, cadmium selenide telluride CdSeTe, cadmium sulfide telluride CdSTe, zinc selenide sulfide ZnSeS, zinc selenide telluride ZnSeTe, zinc sulfide telluride ZnSTe, mercury selenide sulfide HgSeS, mercury selenide telluride HgSeTe, mercury sulfide telluride HgSTe, cadmium zinc sulfide CdZnS, cadmium zinc selenide CdZnSe, cadmium zinc telluride CdZnTe, cadmium mercury sulfide CdHgS, cadmium mercury selenide CdHgSe, cadmium mercury telluride CdHgTe, mercury zinc sulfide HgZnS and mercury zinc selenide HgZnSe; and quaternary compounds, for example, cadmium zinc selenide sulfide CdZnSeS, cadmium zinc selenide telluride CdZnSeTe, cadmium zinc sulfide tellurium CdZnSTe, cadmium mercury selenide sulfide CdHgSeS, cadmium mercury selenide telluride CdHgSeTe, cadmium mercury sulfide telluride CdHgSTe, mercury zinc selenide sulfide HgZnSeS, mercury zinc selenide telluride HgZnSeTe and mercury zinc sulfide telluride HgZnSTe.

Exemplary Group III-V semiconductor compounds include binary compounds, for example gallium nitride GaN, gallium phosphide GaP, gallium arsenide GaAs, gallium antimonide GaSb, aluminum nitride AN, aluminum phosphide AlP, aluminum arsenide AlAs, aluminum antimonide AlSb, indium nitride InN, indium phosphide InP, indium arsenide InAs and indium antimonide InSb; ternary compounds, for example, gallium nitride phosphide GaNP, gallium nitride arsenide GaNAs, gallium nitride antimonide GaNSb, gallium phosphide arsenide GaPAs, gallium phosphide antimonide GaPSb, aluminum nitride phosphide AlNP, aluminum nitride arsenide AINAs, aluminum nitride antimonide AlNSb, aluminum phosphide arsenide AlPAs, aluminum phosphide antimonide AlPSb, indium nitride phosphide InNP, indium nitride arsenide InNAs, indium nitride antimonide InN Sb, indium phosphide arsenide InPAs, indium lead antimonide InPSb, gallium aluminum nitride phosphide GaA1NP, aluminum gallium nitride AlGaN, aluminum gallium phosphide AlGaP, aluminum gallium arsenide AlGaAs, aluminum gallium antimonide AlGaSb, indium gallium nitride InGaN, indium gallium phosphide InGaP, indium gallium arsenide InGaAs, indium gallium antimonide InGaSb, aluminum indium nitride AlInN, aluminum indium phosphide AlInP, aluminum indium arsenide AlinAs and AllnSb; and quaternary compounds, for example., gallium aluminum nitride arsenide GaA1NAs, gallium aluminum nitride antimonide GaA1NSb, gallium aluminum phosphide arsenide GaA1PAs, gallium aluminum phosphide antimonide GaAlPSb, gallium indium nitride phosphide GaInNP, gallium indium nitride arsenide GaInNAs,gallium indium nitride antimonide GaInNSb, gallium indium phosphide arsenide GaInPAs, gallium indium phosphide antimonide GaInPSb, Indium aluminum nitride phosphide InAlNP, indium aluminum nitride arsenide InAlNAs, indium aluminum nitride antimonide InA1NSb, indium aluminum phosphide arsenide InAlPAs and indium aluminum phosphide antimony InAlPSb.

Exemplary Group IV-VI semiconductor compounds include binary compounds, for example, tin sulfide SnS, tin selenide SnSe, tin telluride SnTe, lead sulfide PbS, lead selenide PbSe and lead telluride PbTe; ternary compounds, for example, tin selenide sulfide SnSeS, tin selenide telluride SnSeTe, tin sulfide telluride SnSTe, lead selenide sulfide PbSeS, lead selenide telluride PbSeTe, lead sulfide telluride PbSTe, tin lead sulfide SnPbS, tin lead selenide SnPbSe and tin lead telluride SnPbTe; and quaternary compounds, for example, tin lead sulfide selenide SnPbSSe, selenide lead selenide telluride SnPbSeTe and tin lead sulfide telluride SnPbSTe.

Exemplary Group IV semiconductor compounds include unary compounds, for example, silicon Si and germanium Ge; and binary compounds, for example, silicon carbide SiC and silicon germanium SiGe.

In yet further aspects each of the plurality of nanoparticle quantum dots include a concentration-gradient quantum dot. A concentration-gradient quantum dot includes an alloy of at least two semiconductors. The concentration (molar ratio) of the first semiconductor gradually increases from the core of the quantum dot to the outer surface of the quantum dot, and the concentration (molar ratio) of the second semiconductor gradually decreases from the core of the quantum dot to the outer surface of the quantum dot. Exemplary concentration-gradient quantum dots are described in, e.g., U.S. Pat. No. 7,981,667, the disclosure of which is incorporated herein by this reference in its entirety.

In one aspect, the concentration-gradient quantum dot includes two semiconductors, a first semiconductor having the formula

CdₓZn₁₋ₓS_{y}Se_{1-y}

haying a maximum molar ratio at the core of the stabilized quantum dot that gradually decreases to a minimum molar ratio at the outer surface of the quantum dot and a second semiconductor having the formula

Zn_{z}Se_{1-z}S_{w}Se_{1-w}

haying a maximum molar ratio at the outer surface of the stabilized quantum dot that gradually decreases to a minimum molar ratio at the core of the stabilized quantum dot.

In another aspect, the concentration-gradient quantum dot includes two semiconductors, a first semiconductor having the formula

CdZnₓS₁₋ₓ

having a maximum molar ratio at the core of the stabilized quantum dot that gradually decreases to a minimum molar ratio at the outer surface of the quantum dot and a second semiconductor having the formula

ZnCd_{z}S_{1-z}

and having a maximum molar ratio at the outer surface of the stabilized quantum dot that gradually decreases to a minimum molar ratio at the core of the stabilized quantum dot.

Where the plurality of nanoparticle quantum dots are described herein as having a shell or a multi-shell structure (i.e., a core and at least one shell), the core and the shell or plurality of shells may independently be formed of the semiconductor materials described above. Examples of semiconductor shells include, but are not limited to, CdS, CdSe, CdTe, PbS, PbSe, PbTe, ZnS, ZnSe, ZnTe, CdZnS, CdZnSe, CdZnTe, CdZnTeSe, CdZnSSe, GaAs, GaP, GaN, InP, InAs, GaAlAs, GaA1P, GaA1N, GaInN, GaAlAsP, or GaAlInN.

The plurality of nanoparticle quantum dots may have a size of from about 1 nanometer (nm) to about 100 nm in some aspects. In particular aspects the plurality of nanoparticle quantum dots have a size of from about 1 nm to about 50 nm, or from about 1 nm to about 30 nm.

The quantum dot composition in some aspects includes from about 0.0001 wt % to about 10 wt % nanoparticle quantum dots, or in particular aspects from about 0.001 wt % to about 1 wt % nanoparticle quantum dots.

The plurality of nanoparticle quantum dots are present in the quantum dot composition as a quantum dot concentrate including a plurality of nanoparticle quantum dots and an acrylic polymer, a methacrylic polymer, or a combination thereof. As used herein, an “acrylic polymer” is a polymer based on acrylic (propenoic) acid and its homologues and their derivatives. Exemplary acrylic polymers are based on: acrylic acid itself; methacrylic acid; esters of acrylic acid; esters of methacrylic acid; acrylonitrile; acrylamide; cyanoacrylates; and copolymers of these compounds. One purely exemplary acrylic polymer is poly(acrylic acid) (PAA). As used herein, a “methacrylic polymer” is a polymer based on methacrylic acid; methacrylic polymers are a category of acrylic polymer. An exemplary methacrylic polymer includes, but is not limited to, poly(methyl methacrylate) (PMMA). Exemplary acrylic copolymers include, but are not limited to poly (methyl methacrylate-co-methacrylic acid), poly(methyl methacrylate-co-ethyl acrylate) and poly(methyl methacrylate-co-lauryl methacrylate.

As noted below, the quantum dot concentrate may be prepared as a masterbatch prior to combining the quantum dot concentrate with the polycarbonate resin/polycarbonate copolymer resin and the compatibilizer to form the quantum dot composition. The concentration of nanoparticle quantum dots in the quantum dot concentrate may be from about 0.0001 wt % to about 10 wt %, or in particular aspects from about 0.01 wt % to about 5 wt %. The balance of the quantum dot concentrate may include the acrylic polymer, methacrylic polymer, or combination thereof, although the quantum dot concentrate may also include one or more additional additives as desired. In certain aspects the one or more additional additives include but are not limited to, mold release agents (such as pentaerythritol tetrastearate), ultraviolet (UV) additives (such as a benzotriazole-based UV-light absorber), and thermal stabilizers (such as aryl phosphites). In particular aspects the concentration of the one or more additional additives in the quantum dot concentrate may be from about 0.0001 wt % to about 1 wt %.

The acrylic/methacrylic in the quantum dot concentrate is the base material that provides a supporting structure to prevent agglomeration and/or promote dispersion of the nanoparticle quantum dots as the quantum dot composition is formed. Agglomeration of quantum dots results in reduction of optical properties of the quantum dots due to inter-particle energy transfer (such as, but not limited to Förster Resonance Energy Transfer (FRET), also referred to as fluorescence resonance energy transfer, in which non-radiative energy is transferred from a fluorescent donor (e.g., a quantum dot emitting light at a higher energy) to a lower energy acceptor (e.g., a quantum dot emitting light at a lower energy) through long-range dipole-dipole interactions. In some aspects the acrylic polymer, methacrylic polymer or combination thereof in the quantum dot concentrate may be a specialty grade polymer that has a high degree of branching and/or a high melt viscosity, for example, acrylic polymers or copolymer with long alkyl chains, such as poly(lauryl methacrylate), or poly(lauryl methacrylate-co-methyl methacrylate) or poly(tert-butyl acrylate-co-ethyl acrylate-co-methacrylic acid), so as to further minimize or prevent agglomeration of the nanoparticle quantum dots.

The quantum dot concentrate includes in some aspects from about 90 wt % to about 99.9999 wt % acrylic polymer, methacrylic polymer, or combination thereof, or in particular aspects from about 95 wt % to about 99.99 wt % acrylic polymer, methacrylic polymer, or combination thereof. The quantum dot composition includes in some aspects from about 1 wt % to about 99 wt % acrylic polymer/methacrylic polymer, or in particular aspects from about 20 wt % to about 80 wt % acrylic polymer/methacrylic polymer.

In some aspects the compatibilizer includes a transesterification catalyst, a physical compatibilizer, a plurality of semiconductor nanoparticles passivated with a metal oxide, or a combination thereof.

A transesterification catalyst acts as a reactive compatibilizer to promote transesterification between the polycarbonate resin or polycarbonate copolymer resin and the acrylic polymer/methacrylic polymer. In some aspects the transesterification catalyst includes: a Lewis acid catalyst; an alkoxide of titanium(IV); a basic compound including nitrogen; or a combination thereof. Exemplary Lewis acid catalysts include, but are not limited to, tin(II) chloride SnCl₂, tin(II) chloride hydrate SnCl₂·2H₂O, organotin SnOBu₂, and tin(II) 2-ethylhexanoate. Exemplary alkoxides of titanium(IV) include, but are not limited to, titanium(IV) butoxide and titanium(IV) isopropoxide. Exemplary basic compounds containing nitrogen include, but are not limited to: ammonium hydroxide compounds including an alkyl group or an aryl group such as tetramethylammonium hydroxide, tetraethylammonium hydroxide, tetrabutylammonium hydroxide, trimethylbenzylammonium hydroxide, tetramethylammonium borohydride, tetramethylammonium acetate; basic salts such as tetramethylammonium borate, tetrabutylammonium hydroxyborate, tetrabutylammonium tetraphenylborate, or tetramethylammonium tetraphenylborate; and tertiary amines such as trimethylamine, triethylamine, dimethylbenzylamine, triphenylamine and ammonia.

A physical compatibilizer may be used as the compatibilizer to adsorb at the interface between the polymer phases of the polycarbonate resin or polycarbonate copolymer resin and the acrylic polymer/methacrylic polymer and stabilize the blend. Exemplary physical compatibilizers include, but are not limited to, silica, metal oxide, glass beads, carbon black, clay, chalk, and combinations thereof.

In certain aspects the compatibilizer may include a plurality of semiconductor nanoparticles passivated with a metal oxide. The semiconductor nanoparticles could function as both fluorescence bodies (such as, quantum dots) and as physical compatibilizers to stabilize the polymer phases of the polycarbonate resin or polycarbonate copolymer resin and the acrylic polymer/methacrylic polymer. In some aspects the metal oxide includes alumina (AlOₓ), magnesium oxide (MgOₓ), zirconium oxide (ZrOₓ), titanium oxide (TiOₓ), silicon oxide (SiOₓ), chromium oxide (CrOₓ), copper oxide (CuOₓ), cobalt oxide (CoO), iron oxide (FeOₓ), vanadium oxide (VOₓ), or a combination thereof. The plurality of semiconductor nanoparticles may include any of the nanoparticles described herein. In particular aspects the semiconductor nanoparticles include CdSe, CdS, InP or a combination thereof.

The quantum dot composition may include from about from about 0.0001 wt % to about 5 wt % compatibilizer in some aspects, or in particular aspects from about 0.01 wt % to about 2 wt % compatibilizer.

The quantum dot composition may optionally include an additional content of acrylic polymer, methacrylic polymer, or a combination thereof. The additional content of acrylic polymer and/or methacrylic polymer may be the same acrylic polymer/methacrylic polymer as that included in the quantum dot concentrate or it may be a different type of acrylic polymer/methacrylic polymer. In certain aspects the additional content of acrylic polymer/methacrylic polymer is included to further modify the compatibility of the acrylic polymer/methacrylic polymer in the quantum dot concentrate and the polycarbonate resin/polycarbonate copolymer resin. In some aspects the additional content of acrylic polymer/methacrylic polymer is a commodity grade polymer. In some aspects the additional content of acrylic polymer/methacrylic polymer is from about 0 wt % to about 90 wt % of the total content of the quantum dot composition, or in particular aspects from about 0 wt % to about 40 wt %, or from about 20 wt. % to about 40 wt %, of the total content of the quantum dot composition.

The quantum dot composition may include the components described herein and optional components including but not limited to a scattering material, a dispersant, a binder, a scavenger, a stabilizer, a curing agent, a mold release agent, a ultraviolet UV stabilizer, and a combination thereof.

Quantum dot compositions according to aspects of the disclosure have improved optical properties as compared to conventional compositions that do not include a compatibilizer. In certain aspects the quantum dot composition exhibits a transmission in the visible spectrum (about 390 nanometers (nm) to about 700 nm) of at least about 40% at a sample thickness of 0.5 millimeter (mm). In particular aspects, the quantum dot composition exhibits a transmission that is at least about 30% greater than the transmission of a substantially similar reference quantum dot composition that does not include the compatibilizer. As used herein, a “substantially similar reference quantum dot composition” is a reference quantum dot composition that includes the same components (for example, acrylic/methacrylic polymer, polycarbonate resin and quantum dot composition) and the same amounts of the components, as the claimed (or described) inventive composition, except that the reference composition does not include the indicated component (for example, a compatibilizer). In other words, the reference composition is otherwise identical to the claimed/described composition but for the exclusion of the indicated component.

### Methods for Making a Nanoparticle Quantum Dot Composition

Aspects of the disclosure further relate to methods for making a quantum dot composition, including:

a. combining a plurality of nanoparticle quantum dots with an acrylic polymer, a methacrylic polymer or a combination thereof to form a quantum dot concentrate; and

b. combining the quantum dot concentrate with: a polycarbonate resin, a polycarbonate copolymer resin, or a combination thereof; and a compatibilizer for promoting dispersion of the nanoparticle quantum dots in the quantum dot composition.

The plurality of nanoparticle quantum dots, the acrylic polymer/methacrylic polymer, the polycarbonate resin/polycarbonate copolymer resin and compatibilizer may include any of the materials, and in any of the amounts, discussed above for the quantum dot compositions and are not duplicated herein.

As noted, the method includes forming a quantum dot concentrate by combining a plurality of nanoparticle quantum dots with an acrylic polymer, a methacrylic polymer or a combination thereof. The quantum dot concentrate may be prepared as a masterbatch prior to combining the quantum dot concentrate with the polycarbonate resin/polycarbonate copolymer resin and the compatibilizer. The plurality of nanoparticle quantum dots may be combined with the acrylic/methacrylic polymer in a solution with a solvent, such as but not limited to toluene, benzene, a high boiling point isopropyl alcohol or acetone. As the solvent is stripped (for example, evaporated) from the solution, the nanoparticle quantum dots remain well dispersed in the acrylic/methacrylic polymer, and as the solvent is finally removed the quantum dot concentrate (for example, masterbatch) remains.

The quantum dot concentrate may then be combined with the polycarbonate resin/polycarbonate copolymer resin and the compatibilizer to form the quantum dot composition. In some aspects the components are combined in an extruder to form the quantum dot composition. The quantum dot composition may be formed in any other suitable manner, including but not limited to a melt blending or melt spinning.

In such an extrusion process any of the foregoing components described herein may first be dry blended together, then fed into an extruder from one or multi-feeders, or separately fed into an extruder from one or multi-feeders. One or more of the components may also be fed into the extruder from a throat hopper or any side feeders.

The quantum dot composition may include the components described herein and optional components including but not limited to a scattering material, a dispersant, a binder, a scavenger, a stabilizer and a combination thereof.

The extruder may have a single screw, multiple screws, intermeshing co-rotating or counter rotating screws, non-intermeshing co-rotating or counter rotating screws, reciprocating screws, conical screws, screws with pins, screws with screens, barrels with pins, rolls, rams, helical rotors, co-kneaders, disc-pack processors, various other types of extrusion equipment, or combinations comprising at least one of the foregoing.

The barrel temperature on the extruder during compounding can be set at the temperature where at least a portion of the polymer(s) has reached a temperature greater than or equal to about the melting temperature, if the polymer is a semi-crystalline organic polymer, or the flow point (for example, the glass transition temperature) if the polymer is an amorphous polymer.

The mixture including the foregoing mentioned components may be subject to multiple blending and forming steps if desirable. For example, the composition may first be extruded and formed into pellets. The pellets may then be fed into a molding machine where it may be formed into any desirable shape or product. Alternatively, the composition emanating from a single melt blender may be formed into sheets or strands and subjected to post-extrusion processes such as annealing, uniaxial or biaxial orientation.

The temperature of the melt in the present process may in some aspects be maintained as low as possible in order to avoid excessive degradation of the components (for example, the polymer(s) in the quantum dot composition or the nanoparticle quantum dots. In certain aspects the melt temperature is maintained between about 200° C. and about 300° C., or even between about 230° C. and about 250° C. In some aspects the melt processed composition exits processing equipment such as an extruder through small exit holes in a die. The resulting strands of molten resin may be cooled by passing the strands through a water bath. The cooled strands can be chopped into small pellets for packaging and further handling.

In some aspects the quantum dot composition may be extruded into a film.

### Articles Including the Quantum Dot Composition

Aspects of the disclosure also relate to an article including the quantum dot composition described herein. In some aspects the article is a film, such as but not limited to a film for a display of an electronic device. The electronic device may include but is not limited to a mobile device, a tablet device, a gaming system, a handheld electronic device, a wearable device, a television, a desktop computer, or a laptop computer.

Various combinations of elements of this disclosure are encompassed by this disclosure, for example, combinations of elements from dependent claims that depend upon the same independent claim. Aspects of the Disclosure

In various aspects, the present disclosure pertains to and includes at least the following aspects.

Aspect 1: A quantum dot composition comprising:

a. a polycarbonate resin, a polycarbonate copolymer resin, or a combination thereof;

b. a quantum dot concentrate comprising a plurality of nanoparticle quantum dots and an acrylic polymer, a methacrylic polymer, or a combination thereof and

c. a compatibilizer for promoting dispersion of the nanoparticle quantum dots in the quantum dot composition.

Aspect 2: The quantum dot composition according to Aspect 1, wherein the compatibilizer comprises a transesterification catalyst, a physical compatibilizer, a plurality of semiconductor nanoparticles passivated with a metal oxide, or a combination thereof.

Aspect 3: The quantum dot composition according to Aspect 1 or 2, wherein the quantum dot composition further comprises an additional content of acrylic polymer, methacrylic polymer, or a combination thereof.

Aspect 4: The quantum dot composition according to any of Aspects 1 to 3, wherein the quantum dot composition comprises from about 0.0001 wt % to about 10 wt % nanoparticle quantum dots.

Aspect 5: The quantum dot composition according to any of Aspects 1 to 4, wherein the quantum dot composition comprises from about 0.0001 wt % to about 5 wt % compatibilizer.

Aspect 6: The quantum dot composition according to any of Aspects 2 to 5, wherein the compatibilizer comprises a transesterification catalyst comprising: a Lewis acid catalyst; an alkoxide of titanium(IV); a basic compound including nitrogen; or a combination thereof.

Aspect 7: The quantum dot composition according to Aspect 6, wherein the transesterification catalyst comprises SnCl2 or SnCl₂·2H₂O.

Aspect 8: The quantum dot composition according to any of Aspects 2 to 5, wherein the compatibilizer comprises a physical compatibilizer comprising silica, metal oxide, glass beads, carbon black, clay, chalk, or a combination thereof.

Aspect 9: The quantum dot composition according to any of Aspects 2 to 5, wherein the compatibilizer comprises a plurality of semiconductor nanoparticles passivated with a metal oxide, and the metal oxide comprises alumina (AlOₓ), magnesium oxide (MgOₓ), zirconium oxide (ZrOₓ), titanium oxide (TiOₓ), silicon oxide (SiOₓ), chromium oxide (CrOₓ), copper oxide (CuOₓ), cobalt oxide (CoO), iron oxide (FeOₓ), vanadium oxide (VOₓ), or a combination thereof.

Aspect 10: The quantum dot composition according to any of Aspects 1 to 9, wherein the quantum dot composition comprises from about 0.01 wt % to about 2 wt % compatibilizer.

Aspect 11: The quantum dot composition according to any of Aspects 1 to 10, wherein the quantum dot composition exhibits a transmission in the visible spectrum of at least about 40% at a sample thickness of 0.5 millimeter (mm).

Aspect 12: The quantum dot composition according to any of Aspects 1 to 11, wherein the quantum dot composition exhibits a transmission that is at least about 30% greater than the transmission of a substantially similar reference quantum dot composition that does not include the compatibilizer.

Aspect 13: An article comprising the quantum dot composition according to any of Aspects 1 to 12.

Aspect 14: The article according to Aspect 13, wherein the article is a film for a display of an electronic device.

Aspect 15: The article according to Aspect 14, wherein the electronic device is a mobile device, a tablet device, a gaming system, a handheld electronic device, a wearable device, a television, a desktop computer, or a laptop computer.

Aspect 16: A method for making a quantum dot composition, comprising:

a. combining a plurality of nanoparticle quantum dots with an acrylic polymer, a methacrylic polymer or a combination thereof to form a quantum dot concentrate; and b. combining the quantum dot concentrate with: a polycarbonate resin, a polycarbonate copolymer resin, or a combination thereof; and a compatibilizer for promoting dispersion of the nanoparticle quantum dots in the quantum dot composition.

Aspect 17: The method according to Aspect 16, further comprising extruding the quantum dot composition into a film.

Aspect 18: The method according to Aspect 16 or 17, wherein the compatibilizer comprises a transesterification catalyst, a physical compatibilizer, a plurality of semiconductor nanoparticles passivated with a metal oxide, or a combination thereof.

Aspect 19: The method according to any of Aspects 16 to 18, further comprising combining the quantum dot concentrate with an additional content of acrylic polymer, methacrylic polymer, or a combination thereof.

Aspect 20: The method according to any of Aspects 16 to 19, wherein the quantum dot composition comprises from about 0.0001 wt % to about 10 wt % nanoparticle quantum dots.

Aspect 21: The method according to any of Aspects 16 to 20, wherein the quantum dot composition comprises from about 0.0001 wt % to about 5 wt % compatibilizer.

Aspect 22: The method according to any of Aspects 18 to 21, wherein the compatibilizer comprises a transesterification catalyst comprising: a Lewis acid catalyst; an alkoxide of titanium(IV); a basic compound including nitrogen; or a combination thereof.

Aspect 23: The method according to Aspect 22, wherein the transesterification catalyst comprises SnCl2 or SnCl₂·2H₂O.

Aspect 24: The method according to any of Aspects 18 to 21, wherein the compatibilizer comprises a physical compatibilizer comprising silica, metal oxide, glass beads, carbon black, clay, chalk, or a combination thereof.

Aspect 25: The method according to any of Aspects 18 to 21, wherein the compatibilizer comprises a plurality of semiconductor nanoparticles passivated with a metal oxide, and the metal oxide comprises alumina (AlOₓ), magnesium oxide (MgOₓ), zirconium oxide (ZrOₓ), titanium oxide (TiOₓ), silicon oxide (SiOₓ), chromium oxide (CrOₓ), copper oxide (CuOₓ), cobalt oxide (CoO), iron oxide (FeOₓ), vanadium oxide (VOₓ), or a combination thereof.

Aspect 26: The method according to any of Aspects 16 to 25, wherein the quantum dot composition comprises from about 0.01 wt % to about 2 wt % compatibilizer.

Aspect 27: The method according to any of Aspects 16 to 26, wherein the quantum dot composition exhibits a transmission in the visible spectrum of at least about 40% at a sample thickness of 0.5 millimeter (mm).

Aspect 28: The method according to any of Aspects 16 to 27, wherein the quantum dot composition exhibits a transmission that is at least about 30% greater than the transmission of a substantially similar reference quantum dot composition that does not include the compatibilizer.

Aspect 29: An article comprising the quantum dot composition formed according to the method of any of Aspects 16 to 28.

Aspect 30: The article according to Aspect 29, wherein the article is a film for a display of an electronic device.

Aspect 31: The article according to Aspect 30, wherein the electronic device is a mobile device, a tablet device, a gaming system, a handheld electronic device, a wearable device, a television, a desktop computer, or a laptop computer.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary and are not intended to limit the disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric. Unless indicated otherwise, percentages referring to composition are in terms of wt %.

There are numerous variations and combinations of reaction conditions, e.g., component concentrations, desired solvents, solvent mixtures, temperatures, pressures and other reaction ranges and conditions that can be used to optimize the product purity and yield obtained from the described process. Only reasonable and routine experimentation will be required to optimize such process conditions.

### Example 1

A quantum dot concentrate is prepared by combining an acrylic polymer (Mw: 200,000) and red and green quantum dots to achieve a combined quantum dot loading level in the quantum dot concentrate of 0.06 wt %. The quantum dot concentrate is pre-dried and mixed with a pre-dried polycarbonate homopolymer (Mw: 30,000) in a weight ratio of 1:2 and 0.2 wt % SnCl₂ as a compatibilizer. The mixture is gravity fed into a hopper and extruded into a film via a melt extrusion method. The extrusion temperature is set at 240 degrees Celsius (° C.). The content of the quantum dot composition is set forth in Table 1:

TABLE 1

| Component | Amount (wt %) |
|---|---|
| Acrylic polymer | 33 |
| Polycarbonate polymer | 67 |
| Red quantum dots | 0.0025 |
| Green quantum dots | 0.0175 |
| SnCl₂ | 0.2 |

### Example 2

A quantum dot concentrate is prepared by combining an acrylic polymer (Type 1, Mw: 200,000) and red quantum dots to achieve a quantum dot loading level in the quantum dot concentrate of 0.06 wt %. The quantum dot concentrate (10 wt %) is pre-dried and mixed with another acrylic polymer (Type 2, Mw=10,000, 23 wt %, pre-dried) and a polycarbonate polymer (Mw: 30,000, 67 wt %, pre-dried) and 0.2 wt % SnCl₂ as a compatibilizer. The mixture is gravity fed into a hopper and extruded into a film via a melt extrusion method. The extrusion temperature is set at 240° C. The content of the quantum dot composition is set forth in Table 2:

TABLE 2

| Component | Amount (wt %) |
|---|---|
| Acrylic polymer 1 | 10 |
| Acrylic polymer 2 | 23 |
| Polycarbonate polymer | 67 |
| Red quantum dots | 0.02 |
| SnCl₂ | 0.2 |

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

It will be apparent to those skilled in the art that various modifications and variations can be made in the present disclosure without departing from the scope or spirit of the disclosure. Other embodiments of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

The patentable scope of the disclosure is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A quantum dot composition comprising:
a. a polycarbonate resin, a polycarbonate copolymer resin, or a combination thereof;
b. a quantum dot concentrate comprising a plurality of nanoparticle quantum dots and an acrylic polymer, a methacrylic polymer, or a combination thereof; and
c. a compatibilizer for promoting dispersion of the nanoparticle quantum dots in the quantum dot composition.

2. The quantum dot composition according to claim 1, wherein the compatibilizer comprises a transesterification catalyst, a physical compatibilizer, a plurality of semiconductor nanoparticles passivated with a metal oxide, or a combination thereof.

3. The quantum dot composition according to claim 1, wherein the quantum dot composition further comprises an additional content of acrylic polymer, methacrylic polymer, or a combination thereof.

4. The quantum dot composition according to claim 1, wherein the quantum dot composition comprises from about 0.0001 wt % to about 10 wt % nanoparticle quantum dots.

5. The quantum dot composition according to claim 1, wherein the quantum dot composition comprises from about 0.0001 wt % to about 5 wt % compatibilizer.

6. The quantum dot composition according to claim 2, wherein the compatibilizer comprises a transesterification catalyst comprising: a Lewis acid catalyst; an alkoxide of titanium(IV); a basic compound including nitrogen; or a combination thereof.

7. The quantum dot composition according to claim 6, wherein the transesterification catalyst comprises SnCl₂ or SnCl₂·2H₂O.

8. The quantum dot composition according to claim 2, wherein the compatibilizer comprises a physical compatibilizer comprising silica, metal oxide, glass beads, carbon black, clay, chalk, or a combination thereof.

9. The quantum dot composition according to claim 2, wherein the compatibilizer comprises a plurality of semiconductor nanoparticles passivated with a metal oxide, and the metal oxide comprises alumina (AlOₓ), magnesium oxide (MgO₂), zirconium oxide (ZrO₂), titanium oxide (TiO₂), silicon oxide (SiOₓ), chromium oxide (CrO₂), copper oxide (CuO₂), cobalt oxide (CoO), iron oxide (FeO₂), vanadium oxide (VOₓ), or a combination thereof.

10. The quantum dot composition according to claim 1, wherein the quantum dot composition comprises from about 0.01 wt % to about 2 wt % compatibilizer.

11. The quantum dot composition according to claim 1, wherein the quantum dot composition exhibits a transmission in the visible spectrum of at least about 40% at a sample thickness of 0.5 millimeter (mm).

12. The quantum dot composition according to claim 1, wherein the quantum dot composition exhibits a transmission that is at least about 30% greater than the transmission of a substantially similar reference quantum dot composition that does not include the compatibilizer.

13. An article comprising the quantum dot composition according to claim 1.

14. The article according to claim 13, wherein the article is a film for a display of an electronic device.

15. The article according to claim 14, wherein the electronic device is a mobile device, a tablet device, a gaming system, a handheld electronic device, a wearable device, a television, a desktop computer, or a laptop computer.

16. A method for making a quantum dot composition, comprising:
a. combining a plurality of nanoparticle quantum dots with an acrylic polymer, a methacrylic polymer or a combination thereof to form a quantum dot concentrate; and
b. combining the quantum dot concentrate with: a polycarbonate resin, a polycarbonate copolymer resin, or a combination thereof; and a compatibilizer for promoting dispersion of the nanoparticle quantum dots in the quantum dot composition.

17. The method according to claim 16, further comprising extruding the quantum dot composition into a film.

18. The method according to claim 16, wherein the compatibilizer comprises a transesterification catalyst, a physical compatibilizer, a plurality of semiconductor nanoparticles passivated with a metal oxide, or a combination thereof.

19. The method according to any of claims 16, further comprising combining the quantum dot concentrate with an additional content of acrylic polymer, methacrylic polymer, or a combination thereof.

20. The method according to any of claims 16, wherein the quantum dot composition comprises from about 0.0001 wt % to about 10 wt % nanoparticle quantum dots.
